(19) United States
(12) Patent Application Publication
(10) Pub. No.: US 2023/0196699 A1
(43) Pub. Date: Jun. 22, 2023

(54) METHOD AND APPARATUS FOR REGISTRATING POINT CLOUD DATA SETS

(71) Applicant: Electronics and Telecommunications Research Institute, Daejeon (KR)

(72) Inventor: Hyuk Min KWON, Daejeon (KR)

(73) Assignee: Electronics and Telecommunications Research Institute, Daejeon (KR)

(21) Appl. No.: 17/889,751

(22) Filed: Aug. 17, 2022

(30) Foreign Application Priority Data
Dec. 20, 2021 (KR) 10-2021-0182603

(51) Int. Cl. G06T 19/20; G06V 20/64; G06V 10/26; G01S 17/89

(52) U.S. Cl. CPC G06T 19/20; G06V 20/64; G06V 10/26; G01S 17/89; G06T 2219/2016; G06T 2210/56; G06T 2219/2004

(57) ABSTRACT

The present disclosure may provide a method and apparatus for registrating point cloud data sets. The method for registrating point cloud data sets may include extracting at least one plane from a first point cloud data set and a second point cloud data set respectively which are to be registered, performing an initial registration based on an identical plane among the extracted at least one plane, and performing optimization for a size, a location and a direction of the first point cloud data set and the second point cloud data set, and the first point cloud data set and the second point cloud data set may include data obtained through sensors placed in different locations.

### CROSS REFERENCE TO RELATED APPLICATION

The present application claims priority under 35 U.S.C. § 119(a) to Korean application No. KR 10-2021-0182603, filed Dec. 20, 2021, in the Korean Intellectual Property Office, the entire contents of which are incorporated herein for all purposes by this reference.

### BACKGROUND OF THE INVENTION

### Field of the Invention

The present disclosure may provide a method and apparatus for registrating point cloud data sets.

More particularly, the present disclosure may provide a method and apparatus for registrating point cloud data sets that are generated by different devices.

### Description of the Related Art

3-dimensional point cloud data is a set of points which belong to a coordinate system in a 3-dimensional space. Generally, in a 3-dimensional coordinate system, a point is specified by a combination of an x coordinate, a y coordinate and a z coordinate. In this case, individual points in 3-dimensional point cloud data may be construed as containing respective pieces of location information. Accordingly, the surface or shape of a thing, geography, or the form or arrangement of structures, that is, location information may be measured using a device with a distance measurement sensor or camera, and corresponding results may be recorded as point cloud data. As point cloud data of a 3-dimensional space contains more abundant information than those of a 2-dimensional space, such data is processed as necessary, and there are various processing methods.

Among such methods using sets of 3-dimensional points, segmentation, detection and voxelization are widely used: segmentation sorts out necessary data for a particular work by distinguishing and classifying point cloud data according to point features, detection distinguishes and recognizes objects by means of point cloud data, and voxelization partitions point cloud data into voxels to be used for AI-based deep learning and the like. Here, voxelization means a process of partitioning and representing point cloud data into cubes with a predetermined size on x-y-z coordinate axes based on a predetermined criterion, for faster and easier processing of a massive amount of 3-dimensional point cloud data.

In order to obtain 3-dimensional data like 3-dimensional point cloud data, a procedure of obtaining 3-dimensional data by using light detection and ranging (LiDAR), a camera and the like is required. Such 3-dimensional data are actively used for autonomous driving, metaverse, cultural heritage restoration and the like. In order to obtain more accurate and detailed 3-dimensional data, a plurality of sensors are used at the same time, and data obtained in various locations and directions are utilized. Herein, as a plurality of sensors cannot be present in a same location, data obtained from each sensor may be located in a different coordinate system.

For 3-dimensional data sets in different locations and directions, when the difference is small, local registration may be applied, and when the difference is large, global registration may be applied. Compared with local registration, global registration requires a larger amount of computation and has other difficulties. In addition, depending on a type of a sensor, point cloud data obtained using it may have a different size of coordinate system. For example, LiDAR uses a real distance (e.g., a meter unit), while point cloud data obtained from a camera do not use any real distance unit. Thus, there may be a situation where coordinate systems have different sizes.

### SUMMARY

The present disclosure is directed to provide a method and apparatus for registrating point cloud data sets obtained through different sensors.

The present disclosure is directed to provide a method and apparatus for registrating 3-dimensional data sets through a 4 degrees of freedom (DoF) problem.

The present disclosure is directed to provide a method and apparatus for registrating 3-dimensional data sets by using correspondence of an identical plane.

The present disclosure is directed to provide a method and apparatus for registrating 3-dimensional data sets based on repetition of size adjustment and location/direction adjustment.

According to an embodiment of the present disclosure, a method for registrating point cloud data sets may include extracting at least one plane from a first point cloud data set and a second point cloud data set respectively which are to be registered, performing an initial registration based on an identical plane among the extracted at least one plane, and performing optimization for a size, a location and a direction of the first point cloud data set and the second point cloud data set, and the first point cloud data set and the second point cloud data set may include data obtained through sensors placed in different locations.

According to an embodiment of the present disclosure, the initial registration may be performed by Z-axis rotation, X-axis translation, Y-axis translation, and scaling.

According to an embodiment of the present disclosure, the performing of the initial registration may further include translating at least one of the first point cloud data set or the second point cloud data set or combination thereof so that a center of the identical plane matches between the first point cloud data set and the second point cloud data set, rotating at least one of the first point cloud data set or the second point cloud data set or combination thereof so that the identical plane matches an X-Y plane, and adjusting a size of at least one of the first point cloud data set or the second point cloud data set or combination thereof so that a height of a Z axis becomes identical between the first point cloud data set and the second point cloud data set.

According to an embodiment of the present disclosure, the optimization may be performed by repeating adjustment of a location and a direction and adjustment of a size until a predefined completion condition is satisfied.

According to an embodiment of the present disclosure, the adjustment of the size may be performed by sequentially applying size change values according to a set range and a step unit and by adjusting a range and a step unit for a size change value applied in a next repetition based on an error corresponding to each of the size change values.

According to an embodiment of the present disclosure, the step unit may be determined based on a set degree of precision, and the degree of precision may designate the number of decimal places of a minimum value of the step unit.

According to an embodiment of the present disclosure, the completion condition may include at least one of whether or not the adjustment of the size has been repeated as many times corresponding to a set degree of precision and whether or not a calculated error is below a threshold value.

According to an embodiment of the present disclosure, the at least one plane may be extracted by voxelizing the first point cloud data set and the second point cloud data set and by identifying voxels that constitute the plane.

According to an embodiment of the present disclosure, the at least one plane may be extracted by merging planes with an angle between normal vectors below a threshold value.

According to an embodiment of the present disclosure, the at least one plane may include a plurality of planes, the initial registration may be performed repeatedly based on each of the plurality of planes, and the optimization may be performed using a result of an initial registration with a smallest error among initial registrations that are repeatedly performed.

According to an embodiment of the present disclosure, an apparatus for registrating point cloud data sets may include a transceiver configured to transmit and receive information and a processor configured to control the transceiver, and the processor is further configured to extract at least one plane from the first point cloud data set and the second point cloud data set respectively, to perform an initial registration based on an identical plane among the extracted at least one plane, and to perform optimization for a size, a location and a direction of the first point cloud data set and the second point cloud data set, and the first point cloud data set and the second point cloud data set may include data obtained through sensors placed in different locations.

According to an embodiment of the present disclosure, the initial registration may be performed by Z-axis rotation, X-axis translation, Y-axis translation, and scaling.

According to an embodiment of the present disclosure, the processor may be further configured to translate at least one of the first point cloud data set or the second point cloud data set or combination thereof so that a center of the identical plane matches between the first point cloud data set and the second point cloud data set, to rotate at least one of the first point cloud data set or the second point cloud data set or combination thereof so that the identical plane matches an X-Y plane, and to adjust a size of at least one of the first point cloud data set and the second point cloud data set so that a height of a Z axis becomes identical between the first point cloud data set and the second point cloud data set.

According to an embodiment of the present disclosure, the optimization may be performed by repeating adjustment of a location and a direction and adjustment of a size until a predefined completion condition is satisfied.

According to an embodiment of the present disclosure, the adjustment of the size may be performed by sequentially applying size change values according to a set range and a step unit and by adjusting a range and a step unit for a size change value applied in a next repetition based on an error corresponding to each of the size change values.

According to an embodiment of the present disclosure, the step unit may be determined based on a set degree of precision, and the degree of precision may designate the number of decimal places of a minimum value of the step unit.

According to an embodiment of the present disclosure, the completion condition may include at least one of whether or not the adjustment of the size has been repeated as many times corresponding to a set degree of precision and whether or not a calculated error is below a threshold value.

According to an embodiment of the present disclosure, the at least one plane may be extracted by voxelizing the first point cloud data set and the second point cloud data set and by identifying voxels that constitute the plane.

According to an embodiment of the present disclosure, the at least one plane may be extracted by merging planes with an angle between normal vectors below a threshold value.

According to an embodiment of the present disclosure, the at least one plane may include a plurality of planes, the initial registration may be performed repeatedly based on each of the plurality of planes, and the optimization may be performed using a result of an initial registration with a smallest error among initial registrations that are repeatedly performed.

According to the present disclosure, it is possible to provide a method and apparatus for effectively registrating 3-dimensional data sets that are obtained through sensors placed in different locations.

According to the present disclosure, it is possible to provide a method and apparatus for registrating 3-dimensional data sets through a 4 degrees of freedom (DoF) problem.

According to the present disclosure, it is possible to provide a method and apparatus for registrating 3-dimensional data sets by using correspondence of an identical plane.

According to the present disclosure, it is possible to provide a method and apparatus for registrating 3-dimensional data sets based on repetition of size adjustment and location/direction adjustment.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view showing a system for generating 3-dimensional data for a space according to an embodiment of the present disclosure.

FIG. 2 is a view showing a configuration of a device according to an embodiment of the present disclosure.

FIG. 3 is a view showing a concept of registration of point cloud data sets according to an embodiment of the present disclosure.

FIG. 4 is a view showing a method for registrating point cloud data sets according to an embodiment of the present disclosure.

FIG. 5A and FIG. 5B are views showing a difference of degree of freedom (DoF) according to methods of processing point cloud data sets.

FIG. 6 is a view showing a method for extracting a plane from a point cloud data set according to an embodiment of the present disclosure.

FIG. 7 is a view showing an example of a result of voxelization for a point cloud data set according to an embodiment of the present disclosure.

FIG. 8 is a view showing an example of a result obtained by merging voxels on an identical plane according to an embodiment of the present disclosure.

FIG. 9 is a view showing a method for matching planes of point cloud data sets according to an embodiment of the present disclosure.

FIG. 10 is a view showing an example of a result obtained by matching planes of point cloud data sets according to an embodiment of the present disclosure.

FIG. 11 is a view showing an example of a result obtained by performing optimization for axis translation after matching planes of point cloud data sets according to an embodiment of the present disclosure.

FIG. 12 is a view showing a method for optimizing registration of point cloud data sets according to an embodiment of the present disclosure.

FIG. 13 is a view showing an example of a result obtained by optimizing registration of point cloud data sets according to an embodiment of the present disclosure.

### DETAILED DESCRIPTION

Hereinafter, the embodiments of the present disclosure will be described in detail with reference to the accompanying drawings, so that they can be easily implemented by those skilled in the art. However, the present disclosure may be embodied in many different forms and is not limited to the exemplary embodiments described herein.

In the following description of the embodiments of the present disclosure, a detailed description of known configurations or functions incorporated herein will be omitted when it may make the subject matter of the present disclosure rather unclear. Also, in the drawings, parts not related to the description of the present disclosure are omitted, and like parts are designated by like reference numerals.

In the present disclosure, when a component is referred to as being “linked”, “coupled”, or “connected” to another component, it may encompass not only a direct connection relationship but also an indirect connection relationship through an intermediate component. Also, when a component is referred to as “comprising” or “having” another component, it may mean further inclusion of another component not the exclusion thereof, unless explicitly described to the contrary.

In the present disclosure, the terms first, second and the like are used only for the purpose of distinguishing one component from another, and do not limit the order or importance of components, etc. unless specifically stated otherwise. Thus, within the scope of the present disclosure, a first component in one embodiment may be referred to as a second component in another embodiment, and similarly a second component in one embodiment may be referred to as a first component in another embodiment.

In the present disclosure, components that are distinguished from each other are intended to clearly illustrate respective features, which does not necessarily mean that the components are separate. That is, a plurality of components may be integrated into one hardware or software unit, or a single component may be distributed into a plurality of hardware or software units. Thus, unless otherwise noted, such integrated or distributed embodiments are also included in the scope of the present disclosure.

In the present disclosure, components described in the various embodiments are not necessarily essential components, and some may be optional components. Accordingly, embodiments consisting of a subset of the components described in one embodiment are also included in the scope of the present disclosure. Also, an embodiment that includes other components in addition to the components described in the various embodiments is also included in the scope of the present disclosure.

Advantages and features of the present disclosure, and methods for achieving them will be apparent with reference to the embodiments described below in detail with reference to the accompanying drawings. However, the present disclosure is not limited to the embodiments set forth herein but may be embodied in many different forms, and the embodiments are provided to make disclosed contents of the present disclosure thorough and complete and to completely convey the scope of the present disclosure to those with ordinary skill in the art.

Hereinafter, the present disclosure relates to registrating point cloud data sets, and more particularly, to a technology of registrating point cloud data sets that are generated by different devices. Making or recognizing a model by scanning a 3-dimensional object or environment performs a more important role in various fields. Accordingly, various sensors are used to obtain more precise and realistic data, and a registrating technology described below is expected to perform an important role in actively utilizing various sensors.

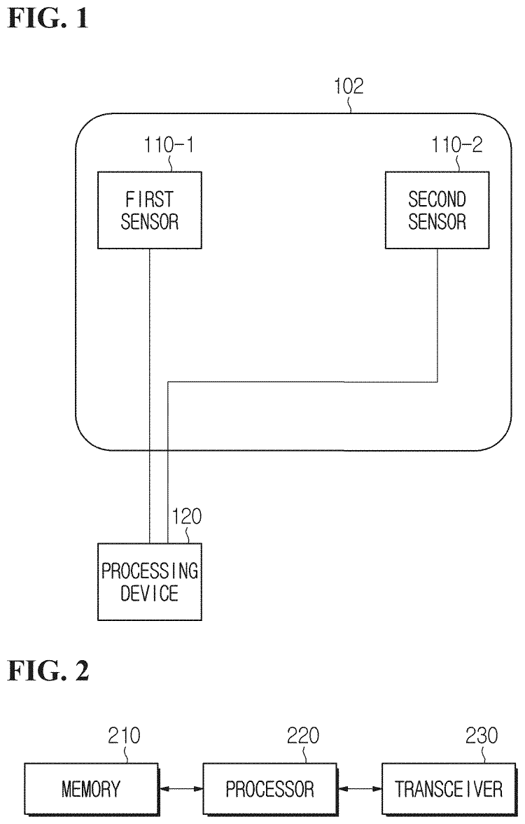

FIG. 1 is a view showing a system for generating 3-dimensional data for a space according to an embodiment of the present disclosure.

Referring to FIG. 1, in order to obtain data about an internal structure of a space 102, a plurality of sensors, including a first sensor 110-1 and a second sensor 110-2, are placed. The space 102 may be a closed space or a space that is at least partially opened. The space 102 may include a single space or a plurality of spaces that are connected with each other. The first sensor 110-1 and the second sensor 110-2 are placed in physically different locations and may be sensors of a same or sensors of different types. As an example, the first sensor 110-1 may be a light detection and ranging (LiDAR) sensor, and the second sensor 110-2 may be a camera.

A processing device 120 processes data sets that are collected by the first sensor 110-1 and the second sensor 110-2 respectively. Thus, the processing device 120 may generate a final 3-dimensional data set for the space 102. According to various embodiments, the processing device 120 may combine a data set generated by the first sensor 110-1 and a data set generated by the second sensor 110-2. By combining 3-dimensional data sets generated by the sensors 110-1 and 110-2 that are placed in different locations, difference for the quality or accuracy of 3-dimensional information according to a location of a sensor may be compensated. In this case, since two data sets may have different axes, directions, locations and the like, processing may be performed according to various embodiments described below. For example, w % ben combining 3-dimensional data sets (e.g., point clouds) obtained through sensors that are placed in different locations with respect to one cubic object, if the sensors are not accurately located with each other, a side of the cube may appear to be thick, or if the error is larger, a side may appear to be double layered.

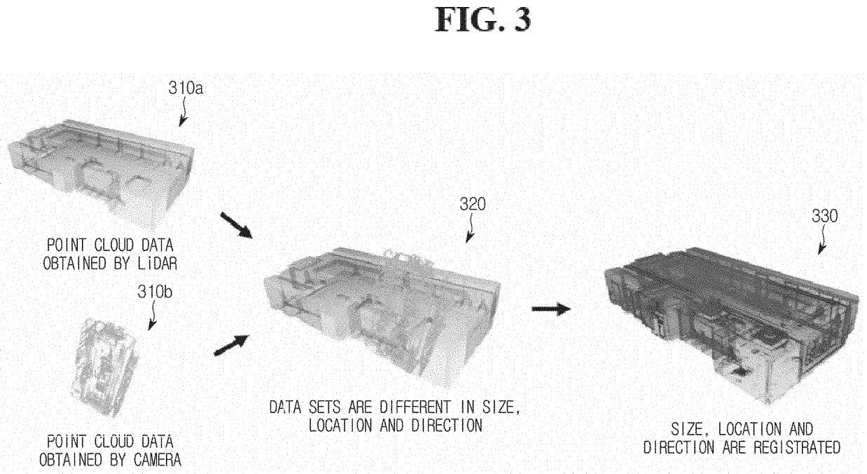

FIG. 2 is a view showing a configuration of a device according to an embodiment of the present disclosure. The configuration of FIG. 2 may be a configuration for the processing device 120 of FIG. 1.

Referring to FIG. 2, the device may further include at least one of a memory 210, a processor 220 and a transceiver 230. Herein, as an example, the memory may store the above-described user policy information or limiting condition information. In addition, the memory 210 may store other relevant information and is not limited to the above-described embodiment. The transceiver 230 may be configured to transmit and receive data or information and is not limited to the above-described embodiment. In addition, the processor 220 may control information that is contained in the memory 210 based on what is described above. In addition, the processor 220 may receive data from another device (e.g., a sensor) through the transceiver 230 and is not limited the above-described embodiment.

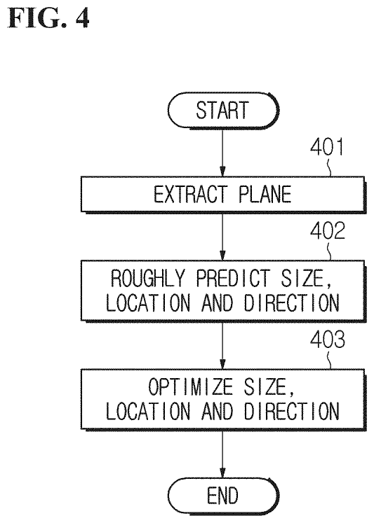

FIG. 3 is a view showing a concept of registration of point cloud data sets according to an embodiment of the present disclosure. Referring to FIG. 3, according to an embodiment of the present disclosure, a first point cloud data set 310a obtained by LiDAR and a second point cloud data set 310b obtained by a camera may be registered. Herein, the LiDAR and the camera may be the sensors 110-1 and 110-2 illustrated in FIG. 1 and may obtain point cloud data in different locations within a corresponding space. Accordingly, an overlapping result 320 of the first point cloud data set 310a and the second point cloud data set 310b shows that the data sets are different in size, location and direction. Therefore, according to various embodiments of the present disclosure, in order to obtain a registered data set 330, at least one of size, location and direction of at least one of the first point cloud data set 310a and the second point cloud data set 310b may be adjusted.

As described above, when data of a 3-dimensional object or space are obtained in various locations and directions through various sensors (e.g., LiDAR, camera), since respective data sets are different in location, direction and size, a registration process is needed to match them into a single coordinate system. When the sizes are identical and the difference is small in location and direction, local registration is sufficient, but when the sizes are identical and the different is large in location and direction, global registration is required. Global registration requires a large amount of computation. When there is a difference only in location and direction, translation and rotation on X axis, Y axis and Z axis respectively are required. That is, the problem of 6-degree of freedom (6-DoF) needs to be solved. When there is a difference also in size, as the problem of 7-DoF with the addition of size needs to be solved, a larger amount of computation than that of the existing global registration is needed, and the accuracy of registration may be significantly degraded. Accordingly, hereinafter, the present disclosure provides a technique of finding out a coordinate system of two point cloud data sets, which are different from each other in size, location and direction, more quickly and accurately.

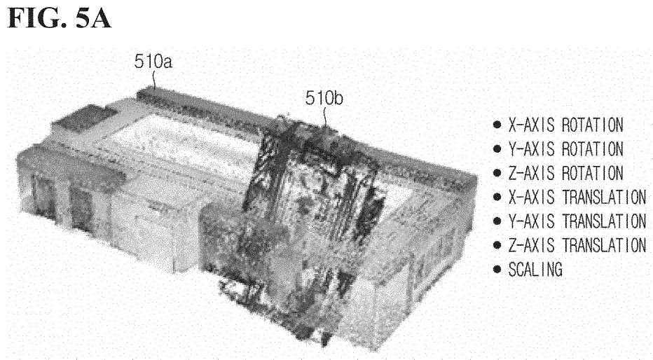

FIG. 4 is a view showing a method for registrating point cloud data sets according to an embodiment of the present disclosure.

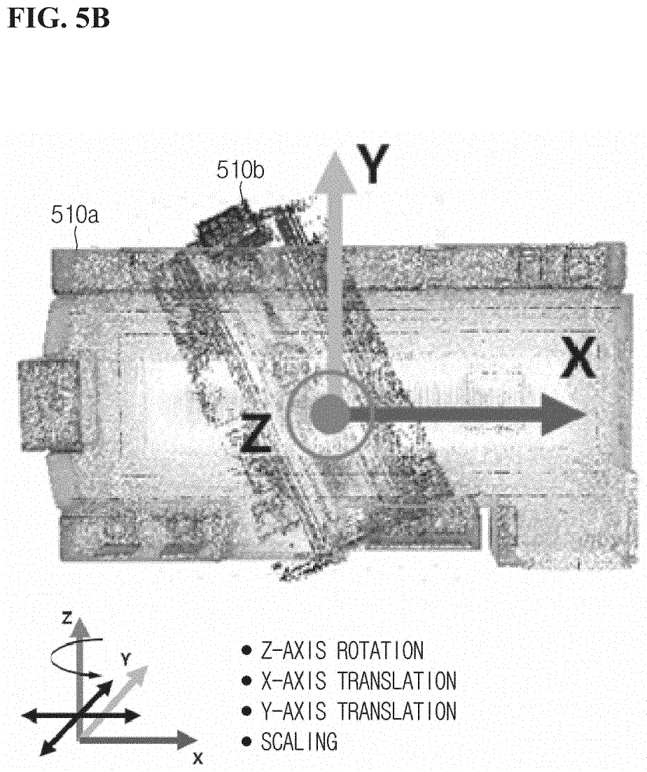

Referring to FIG. 4, a device extracts at least one plane (S401). That is, the device extracts at least one plane from two point cloud data sets respectively which are to be registered. Two point cloud data sets, which are to be registered and are all different in size, location and direction, require registration for 7-degrees of freedom (DoF), including rotation and translation on X axis, Y axis and Z axis respectively and size adjustment. For example, as shown in FIG. 5A, in order to registrate a first point cloud data set 510a and a second point cloud data set 510b, X-axis rotation. Y-axis rotation, Z-axis rotation, X-axis translation, Y-axis translation, Z-axis translation and scaling, that is, a 7-DoF problem is required. However, since an astronomical amount of computation is needed to solve such a 7-DoF problem, efficiency is very low. Accordingly, in order to extract an identical plane from two point cloud data sets different from each other in size, location and direction and to match the extracted plane to a X-Y plane, the device may extract at least one plane from each of the point cloud data sets. When planes are matched, a problem of 7-DoF may be reduced to a problem of 4-DoF including Z-axis rotation, X-axis translation, Y-axis translation and size. For example, as shown in FIG. 5B, in order to registrate the first point cloud data set 510a and the second point cloud data set 510b, Z-axis rotation, X-axis translation, Y-axis translation and scaling, that is, a 4-DoF problem is required.

The device approximately predicts a size, a location and a direction (S402). For example, the device may match the centers of identical planes extracted from the two point cloud data sets and adjust the sizes of the two point cloud data sets. Additionally, the device may further adjust Z-axis rotation, X-axis location and Y-axis location for the two point cloud data sets. Thus, the two point cloud data sets may be roughly registered. In other words, the device matches identical planes among extracted planes and adjusts sizes based on a plane thus matched, thereby initially registrating the two point cloud data sets. Herein, a size is adjusted on an axis perpendicular to the matched plane. That is, the device performs an initial registration based on an identical plane.

The device optimizes the size, location and direction (S403). When the approximate prediction of step S402 is completed, the device performs optimization of the size, location and direction. According to an embodiment, a location/direction optimizing operation and a size optimizing operation may be repeatedly performed in turn. In this case, when the optimizing operations are repeated, the device determines whether to go on or stop performing optimization, based on a criterion for determining whether or not the data sets are registered. According to an embodiment, the criterion for determining whether or not they are registered may be determined based on a degree of precision that is predefined or designated by a user. According to another embodiment, the criterion for determining whether or not they are registered may be determined based on a size of error that is calculated after optimization.

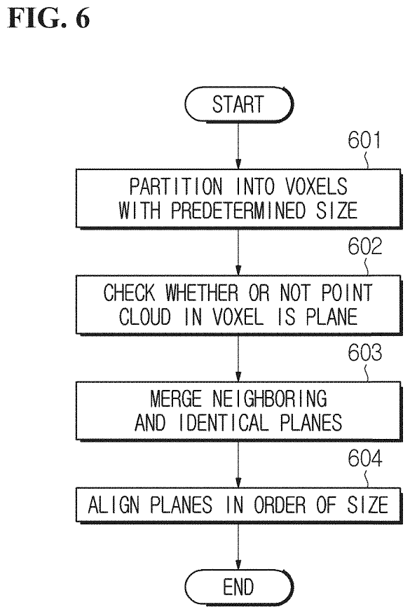

FIG. 6 is a view showing a method for extracting a plane from a point cloud data set according to an embodiment of the present disclosure. FIG. 6 may be a concrete example of the step (e.g., S401) of extracting a plane in FIG. 4.

Referring to FIG. 6, a device partitions each point cloud set into voxels with a predetermined size (S601). The voxel means a unit with a cubic shape for a 3-dimensional space. Herein, the size of a voxel may be predefined or adaptively adjusted.

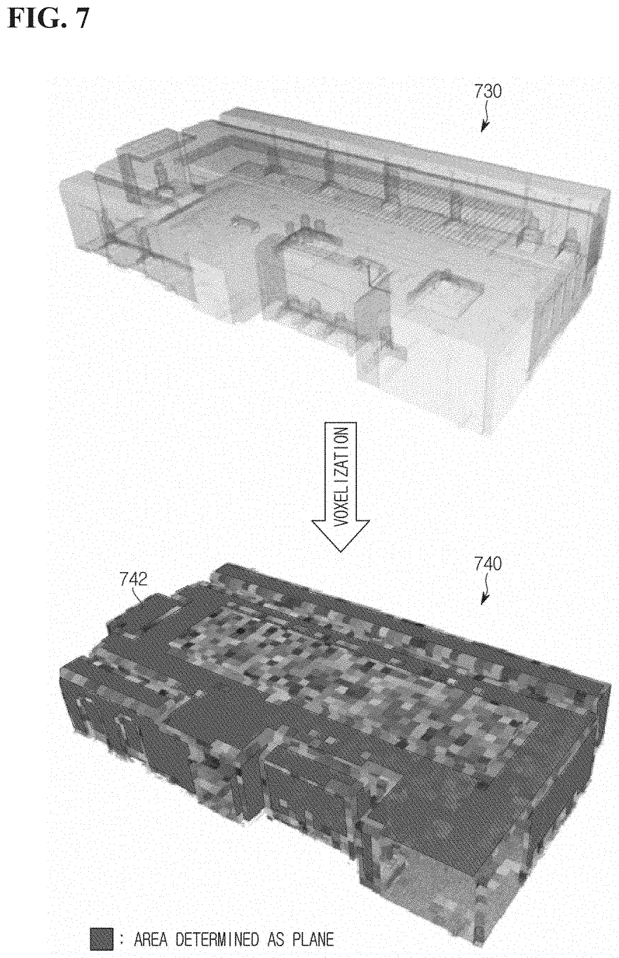

For each voxel, the device checks whether or not point cloud data in the voxel forms a plane (S602). In other words, the device identifies voxels constituting a plane. As an example, checking of whether or not it is a plane may be performed based on a combination of eigen values that are calculated through a principal component analysis (PCA). Specifically, the device may obtain 3 eigen values (e.g., v1, v2 and v3) through a PCA and determine a metric indicating a degree of plane by using the eigen values. Based on the metric thus determined, the device may detect a plane. For example, a plane may be identified as in FIG. 7. Referring to FIG. 7, in a voxelized result of point cloud data 710, an area 742 may be determined as a plane by checking whether or not it is a plane.

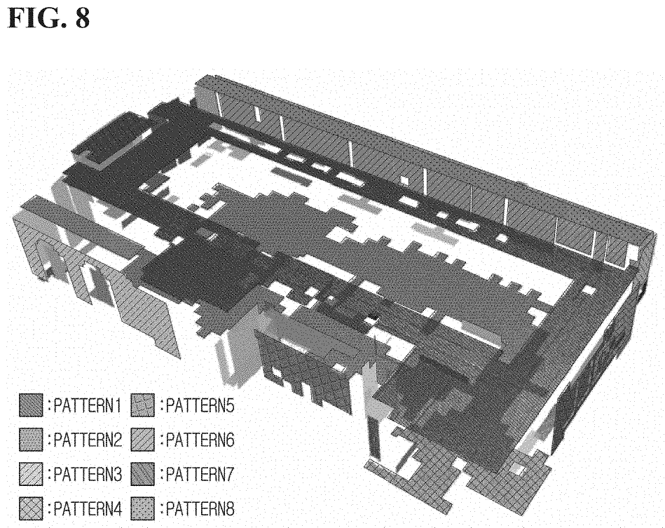

The device merges planes that are determined as neighboring and similar planes (S603). According to an embodiment of the present disclosure, whether or not planes are similar may be determined based on a difference of normal vectors between two planes. Herein, a normal vector may be understood as an eigenvector with a minimum eigen value among eigenvectors that are obtained through a principal component analysis. As a normal vector expresses a direction of a plane, when an angle difference between normal vectors of 2 planes is a threshold value, the 2 planes may be determined as similar planes. For example, planes may be merged as shown in FIG. 8. FIG. 8 illustrates a merging result of neighboring and similar planes for voxels included in the voxelized result 720 of FIG. 7. In FIG. 8, voxels expressed in a same color or pattern constitute a single plane.

The device aligns planes in an order of sizes (S604). For example, the devices may align planes in descending order of widths. Accordingly, a priority order may be determined for planes that are used in an operation of approximately predicting a size, a location and a direction. According to an embodiment, the device may use N planes in descending order from a largest plane. Herein, N may be designated by a user.

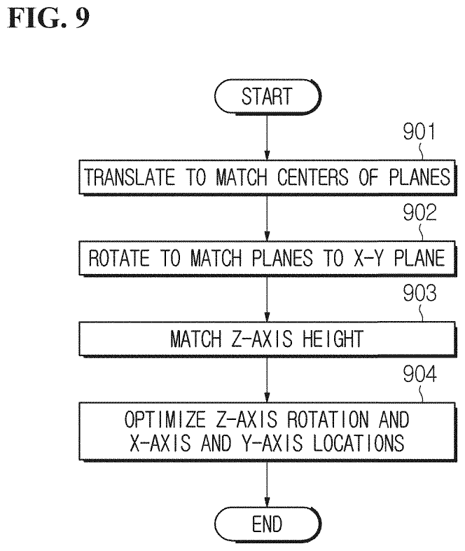

FIG. 9 is a view showing a method for matching planes of point cloud data sets according to an embodiment of the present disclosure. FIG. 9 may be a concrete example for a step (e.g. S402) of predicting a size, a location and a direction in FIG. 4.

Referring to FIG. 9, a device moves at least one of two point cloud data sets to make the centers of planes match each other (S901). In other words, the device identifies a plane of each of the two point cloud data sets and moves at least one of the two point cloud data sets by assuming that 2 identified planes are identical planes, so that the centers of the 2 planes match each other.

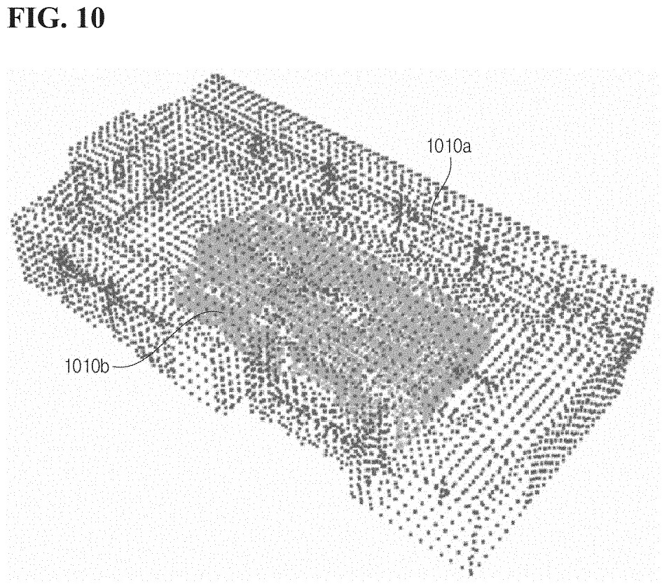

The device rotates at least one of the two point cloud data sets so that the planes with the matched centers match the X-Y plane (S902). For example, the 2 planes may be rotated by using a normal vector of each plane, so that the planes matches the X-Y plane. At this time, the 2 planes may be translated onto the X-Y plane so that the center points of the 2 planes thus matched are placed on a coordinate with Z value of 0. When the 2 identical planes are matched to the X-Y plane, the existing 7 DoF problem may be advantageously reduced to the problem of 4 DoF including Z-axis rotation, X-axis translation, Y-axis translation and scaling. For example, referring to FIG. 10, identical planes of a first point cloud data set 1010a and a second point cloud data set 1010b may be aligned for an X-Y plane and thus the directions of the first point cloud data set 1010a and the second point cloud data set 1010b generally match.

The device matches the Z-axis heights of 2 planes (S903). That is, the device matches the heights of two point cloud data sets. In other words, the device matches the heights of two point cloud data sets by increasing or reducing the height of one of the two point cloud data sets.

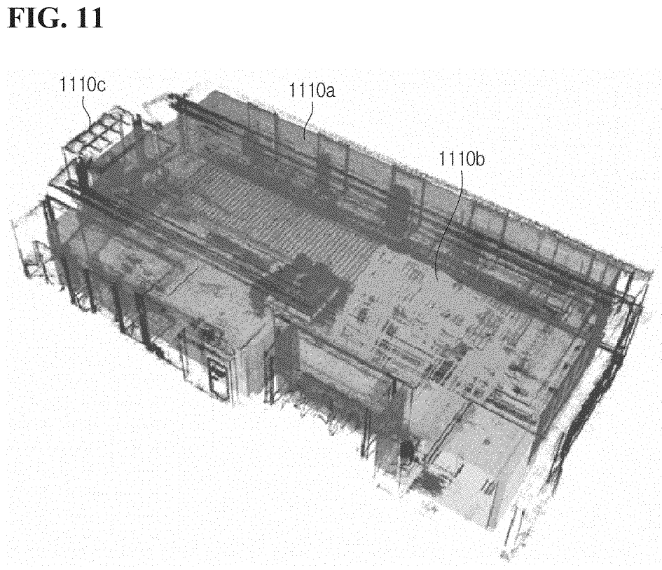

The device optimizes Z-axis rotation and X-axis and Y-axis locations (S904). For example, optimization may be performed using such a technique as the iterative closest point (ICP) that minimizes a distance between two point clouds. As an algorithm minimizing a difference between target point cloud data and source point cloud data, the ICT technique is a technique of determining point pairs by identifying, for each point of the source, a closest point among points in the target point cloud data and of searching for transformation that minimizes a distance between points included in each point pair. Comparison between before and after optimization is shown in FIG. 11. In FIG. 11, a point cloud 1110b is a result obtained by applying a second point cloud data set before rough registration is applied, and a point cloud 1110c is a result obtained by applying the second point cloud data set after rough registration is applied. Thus, with respect to size, location and direction, the second point cloud data set roughly matches the first point cloud data set.

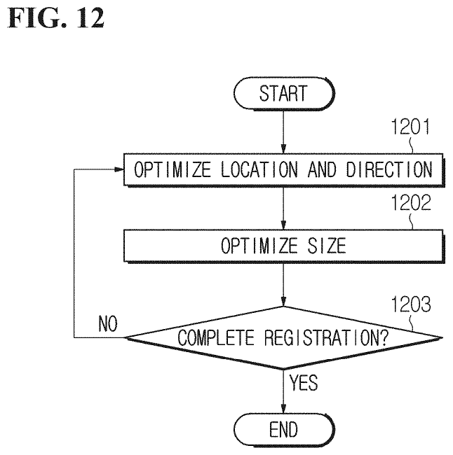

FIG. 12 is a view showing a method for optimizing registration of point cloud data sets according to an embodiment of the present disclosure. FIG. 12 may be a concrete example for a step (e.g., S403) of optimizing size, location and direction in FIG. 4.

Referring to FIG. 12, a device performs location/direction optimization (S1201). As rough registration is performed, the device may optimize a location and a direction by performing local registration. For example, location/direction optimization may be performed using ICP technique that minimizes a distance between two point clouds.

The device performs size optimization (S1202). According to an embodiment, the device designates a range of size change values and applies a size change value that sequentially changes according to a set step unit. In addition, the device identifies a size change value, which provides a smallest error, adjusts a range and a step size and then applies a size change value again. Herein, an error may be calculated according to one of various methods. As an example, the error may be calculated as in Equation 1 below.

$$P = \{ {p}_{0} , {p}_{1} , … , {p}_{n} \} \qquad Equation 1$$

$$Q = \{ {q}_{0} , {q}_{1} , … , {q}_{n} \}$$

$$E = {\sum }_{i = 0}^{n} d ( {p}_{i} , {q}_{i} )$$

In Equation 1, P is a set of points in a first point cloud data set, pᵢ is an i-th point in P, Q is a set of points in a second point cloud data set, qᵢ is an i-th point in Q, E is an error, and d (pᵢ, qᵢ) means a distance between the i-th point in P and the i-th point in Q.

The device determines whether or not registration is sufficient (S1203). That is, the device determines whether or not registration results sufficiently converge by location/direction optimization and size optimization. Depending on how optimization is determined, the device may repeat the step S1201 and the step S1202 or finish this procedure. In other words, the device determines whether to go on or finish performing registration according to a criterion for determining whether or not registration is sufficient. According to an embodiment, the criterion for determining whether or not they are registered may be determined based on a degree of precision that is predefined or designated by a user. According to another embodiment, the criterion for determining whether or not they are registered may be determined based on a size of error that is calculated after optimization.

A concrete example of repetitive optimization may be described as follows. For example, a device designates a range of 0.5 to 1.5 for size change values, calculates an error by applying each of 11 size change values (e.g., 0.5, 0.6, 0.7, 0.8, 0.9, 1.0, 1.1, 1.2, 1.3, 1.4 and 1.5) within the designated range in a unit of 0.1 during a first size optimizing operation and identifies a size change value with a smallest error. Herein, when the smallest error is obtained by applying 1.1, the device performs a similar operation in a unit of 0.01 in a range of 1.05 to 1.15 during a second size optimizing operation. Herein, when the smallest error is obtained by applying 1.13, the device calculates an error by applying a size change value in a unit of 0.001 in a range of 1.125 to 1.135.

The above-described repetition of size optimization may be performed according to a degree of precision of size that is designated or predefined by a user. Herein, the degree of precision is a parameter that designates a number of decimal places to be performed. For example, when the degree of precision of size is 3, optimization is repeated in 1/1,000 unit. When the degree of precision of size is 3, the step S1201 and the step S1202 are repeated as many as three times, and a step size applied to changing a size change value is used in a 0.00X unit. That is, the degree of precision of size may designate the number of decimal places for a minimum value in a step unit.

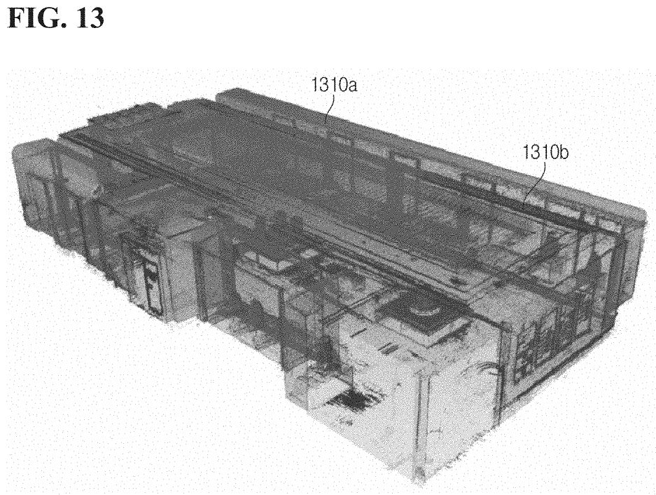

Like the procedure described with reference to FIG. 12, according to repeated optimization, a registered result may be obtained as shown in FIG. 13. FIG. 13 is a view showing an example of a result obtained by optimizing registration of point cloud data sets according to an embodiment of the present disclosure. Referring to FIG. 13, it may be confirmed that two point cloud data sets 1310a and 1310b match.

In order to implement a method according to the present disclosure, the illustrative steps may include an additional step or exclude some steps while including the remaining steps. Alternatively, some steps may be excluded while additional steps are included.

The various embodiments of the disclosure are not intended to be all-inclusive and are intended to illustrate representative aspects of the disclosure, and the features described in the various embodiments may be applied independently or in a combination of two or more.

In addition, the various embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays A general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer.

What is claimed is:

1. A method for registrating point cloud data sets, the method comprising:
extracting at least one plane from a first point cloud data set and a second point cloud data set respectively which are to be registered;
performing an initial registration based on an identical plane among the extracted at least one plane; and
performing optimization for a size, a location and a direction of the first point cloud data set and the second point cloud data set,
wherein the first point cloud data set and the second point cloud data set include data obtained through sensors placed in different locations.

2. The method of claim 1, wherein initial registration is performed by Z-axis rotation, X-axis translation, Y-axis translation, and scaling.

3. The performing of the initial registration further comprising:
translating at least one of the first point cloud data set or the second point cloud data set or combination thereof so that a center of the identical plane matches between the first point cloud data set and the second point cloud data set:
rotating at least one of the first point cloud data set or the second point cloud data set or combination thereof so that the identical plane matches an X-Y plane; and
adjusting a size of at least one of the first point cloud data set or the second point cloud data set or combination thereof so that a height of a Z axis becomes identical between the first point cloud data set and the second point cloud data set.

4. The method of claim 1, wherein the optimization is performed by repeating adjustment of a location and a direction and adjustment of a size until a predefined completion condition is satisfied.

5. The method of claim 4, wherein the adjustment of the size is performed by sequentially applying size change values according to a set range and a step unit and by adjusting a range and a step unit for a size change value applied in a next repetition based on an error corresponding to each of the size change values.

6. The method of claim 5, wherein the step unit is determined based on a set degree of precision, and
wherein the degree of precision designates a number of decimal places of a minimum value of the step unit.

7. The method of claim 4, wherein the completion condition includes at least one of whether or not the adjustment of the size has been repeated as many times corresponding to a set degree of precision and whether or not a calculated error is below a threshold value.

8. The method of claim 1, wherein the at least one plane is extracted by voxelizing the first point cloud data set and the second point cloud data set and by identifying voxels that constitute the plane.

9. The method of claim 8, wherein the at least one plane is extracted by merging planes with an angle between normal vectors below a threshold value.

10. The method of claim 1, wherein the at least one plane includes a plurality of planes,
wherein the initial registration is performed repeatedly based on each of the plurality of planes, and
wherein the optimization is performed by using a result of an initial registration with a smallest error among initial registrations that are repeatedly performed.

11. An apparatus for registrating point cloud data sets, the apparatus comprising:
a transceiver configured to transmit and receive information; and
a processor configured to control the transceiver,
wherein the processor is further configured to:
extract at least one plane from a first point cloud data set and a second point cloud data set respectively which are to be registered:
perform an initial registration based on an identical plane among the extracted at least one plane; and
perform optimization for a size, a location and a direction of the first point cloud data set and the second point cloud data set, and
wherein the first point cloud data set and the second point cloud data set include data obtained through sensors placed in different locations.

12. The apparatus of claim 11, wherein initial registration is performed by Z-axis rotation, X-axis translation, Y-axis translation, and scaling.

13. The apparatus of claim 11, wherein the processor is further configured to:
translate at least one of the first point cloud data set or the second point cloud data set or combination thereof so that a center of the identical plane matches between the first point cloud data set and the second point cloud data set:
rotate at least one of the first point cloud data set or the second point cloud data set or combination thereof so that the identical plane matches an X-Y plane, and
adjust a size of at least one of the first point cloud data set or the second point cloud data set or combination thereof so that a height of a Z axis becomes identical between the first point cloud data set and the second point cloud data set.

14. The apparatus of claim 11, wherein the optimization is performed by repeating adjustment of a location and a direction and adjustment of a size until a predefined completion condition is satisfied.

15. The apparatus of claim 14, wherein the adjustment of the size is performed by sequentially applying size change values according to a set range and a step unit and by adjusting a range and a step unit for a size change value applied in a next repetition based on an error corresponding to each of the size change values.

16. The apparatus of claim 15, wherein the step unit is determined based on a set degree of precision, and
wherein the degree of precision designates a number of decimal places of a minimum value of the step unit.

17. The apparatus of claim 14, wherein the completion condition includes at least one of whether or not the adjustment of the size has been repeated as many times corresponding to a set degree of precision and whether or not a calculated error is below a threshold value.

18. The apparatus of claim 11, wherein the at least one plane is extracted by voxelizing the first point cloud data set and the second point cloud data set and by identifying voxels that constitute the plane.

19. The apparatus of claim 18, wherein the at least one plane is extracted by merging planes with an angle between normal vectors below a threshold value.

20. The apparatus of claim 11, wherein the at least one plane includes a plurality of planes,
wherein the initial registration is performed repeatedly based on each of the plurality of planes, and
wherein the optimization is performed by using a result of an initial registration with a smallest error among initial registrations that are repeatedly performed.
